(19) United States
(12) Patent Application Publication
(10) Pub. No.: US 2013/0147095 A1
(43) Pub. Date: Jun. 13, 2013

(54) METHOD AND APPARATUS FOR MANUFACTURING A MAGNETORHEOLOGICAL ELASTOMER

(71) Applicants: Min Soo Kim, Jinju (KR); Kyung-Mo Yang, Kyung-Mo (KR); Seong Hoon Lee, Ulsan (KR); Kyung-Ho Chung, Hwaseong (KR); Joo-Hwan Lee, Gwangju (KR)

(72) Inventors: Min Soo Kim, Jinju (KR); Kyung-Mo Yang, Kyung-Mo (KR); Seong Hoon Lee, Ulsan (KR); Kyung-Ho Chung, Hwaseong (KR); Joo-Hwan Lee, Gwangju (KR)

(73) Assignees: SUWON-INDUSTRY PARTNERSHIP INSTITUTE AND ACADEMIA COOPERATION FOUNDATION, Gyeonggi-do (KR); HYUNDAI MOTOR COMPANY, Seoul (KR)

(21) Appl. No.: 13/424,810

(22) Filed: Mar. 20, 2012

(30) Foreign Application Priority Data
Dec. 13, 2011 (KR) 10-2011-0133989

(51) Int. Cl. B29B 13/08; C08L 7/00; B29C 35/02

(52) U.S. Cl. 264/496; 425/3; 525/342

(57) ABSTRACT

Disclosed is a method and electromagnetic device for manufacturing an anisotropic magneto-rheological elastomer (MRE) with an improved magneto-rheological effect. The electromagnetic device includes upper and lower electromagnets, and a test piece located therebetween. The upper and lower electromagnets are configured to apply a magnetic field of variable strength, which may be controlled by current applied from a power controller, to the test piece in a desired direction or orientation. More specifically, the device is designed in such a manner that carbonyl iron powder (CIP) (magnetic-responsive particles) dispersed in a magneto-rheological elastomer using natural rubber as a matrix can be oriented in the application direction of the magnetic field. A MRE produced by the method and electromagnetic device of the invention prevents formation of bubbles within a test piece, thereby improving the arrangement/orientation of CIP with the matrix.

### CROSS-REFERENCE TO RELATED APPLICATION

This application claims under 35 U.S.C. §119(a) the benefit of Korean Patent Application No. 10-2011-0133989, filed on Dec. 13, 2011, the entire contents of which are incorporated herein by reference.

### BACKGROUND

(a) Technical Field

The present invention relates to an electromagnetic device for manufacturing an anisotropic Magnetorheological Elastomer (MRE) with improved magnetorheological effect. More particularly, the present invention relates to an electromagnetic device for manufacturing an anisotropic MRE, in which carbonyl iron powder (CIP) (magnetic-responsive particles) dispersed in a magnetorheological elastomer using natural rubber as a matrix can be oriented in the direction of an applied magnetic field.

(b) Background Art

According to the conventional art, an MRE is manufactured using a neodymium magnet and an MRE manufacturing mold having the neodymium magnet inserted therein as shown in FIGS. 1 and 2. This method is disadvantageous because it is difficult to separate the magnet, and to mount a test piece due to a high magnetic force of the neodymium magnet. Furthermore, this method is problematic because it generates bubbles within the MRE test piece, as well as re-arrangement or misalignment of the CIP orientation, thereby reducing physical properties of the MRE.

In an anisotropic MRE manufacturing process using a neodymium magnet, a blended MRE compound is made into a sheet with a thickness of 2 to 4 mm, inserted in a neodymium magnet, and treated in an oven at an adjusted temperature of 80° C. for 30 to 60 minutes so as to induce orientation of CIP. In order to facilitate the orientation of CIP, the temperature of the oven was adjusted to 80° C. Since the temperature greater than 80° C. and the treatment time longer than 60 minutes may cause scorching in a matrix, the temperature of 80° C. and the treatment time of a maximum of 60 minutes were set as optimum process conditions. A MRE compound which has been subjected to induction of CIP orientation is then treated in a hydraulic press at 160° C. for 7 minutes so as to carry out curing of an MRE, resulting in a cured anisotropic MRE.

However, this method suffers from several major disadvantages. For example, it is difficult to obtain a magnetic field strength of 0.5 Tesla or more. Also, due to the characteristics of a molding process, the orientation of the CIP is significantly reduced and non-optimal. Furthermore, as shown in FIG. 3, there this method results in re-arrangement or misalignment of the CIP orientation.

With respect to a MRE manufacturing mold, an MRE compound is filled in a neodymium magnet inserted within the mold, and the mold is introduced into a hydraulic press. The curing of a matrix is then induced in a state where a magnetic field is applied, so as to further induce the orientation of the CIP. However, the MRE manufacturing mold of the conventional art presents several problems. For example, the MRE manufacturing mold makes it difficult to separate the neodymium magnet so as to remove the test piece from the MRE manufacturing mold after the molding process due to the very high magnetic force of neodymium magnets. Furthermore, the MRE manufacturing mold prevents the use of a bumping process, which is generally used to remove inside air during compression molding of rubber; consequently, many bubbles may be formed within the matrix as shown in FIG. 4. This represents a significant disadvantage as the presence of such bubbles results in the production of an MRE with significantly reduced, or non-optimal, physical properties.

The conventional art has suggested methods and devices for manufacturing such an anisotropic MRE. For example, Korean Patent Application Publication No. 2010-0081799 discloses a method for synthesizing a magnetic composite particle by coating polyvinyl butyral on carbonyl iron. Additionally, Korean Patent Application Publication No. 2011-0102644 discloses a vibration controlling device of a hollow shaft using an MRE, in which the MRE is obtained by adding particles (such as CIP) having a polarity by a magnetic field to a polymer such as natural rubber, and silicon rubber. Also, U.S. Pat. No. 7,070,708 discloses a magnetorheological fluid, which is obtained by dispersing magnetic responsive particles (carbonyl iron particles) in a natural rubber compound and silicon oil. As another example, Korean Patent Application Publication No. 2011-0001496 discloses a method and a device for manufacturing an elastomer with a variable modulus, in which the elastomer is obtained by mixing carbonyl iron powder (CIP) as magnetic responsive particles with natural rubber, and further mixing zinc oxide, stearic acid, sulfenamide, and sulfur with the mixture. However, despite the use of magnetic responsive components in all of these manufacturing methods, the problems, enumerated above, which are caused by the use of a magnet in the devices are not overcome.

Accordingly, there is a need for a method and apparatus for manufacturing an anisotropic MRE with improved properties.

### SUMMARY OF THE DISCLOSURE

The present invention provides a method and electromagnetic device for manufacturing an anisotropic Magnetorheological Elastomer (MRE) with improved magnetorheological properties, which overcomes the aforementioned problems associated with the conventional art MRE manufacturing methods, such as a method using a neodymium magnet, and a method using a mold having a neodymium magnet therein.

In one aspect, the invention provides an electromagnetic device that is able to more efficiently induce CIP orientation when a magnetic field is applied as compared to the case where a standard magnet is used. The electromagnetic device of the invention makes it is possible to control the strength of a magnetic field, and to achieve a higher strength of the magnetic field, which has the tremendous advantage of allowing the prevention of bubbles within an MRE test piece, thereby solving the conventional art problem of the re-arrangement or misalignment of oriented CIP within the MRE. This increases the MRE's magnetorheological effect showing a modulus difference before and after magnetic field application.

An object of the present invention is to provide a novel electromagnetic device for improving a magnetorheological (MR) effect, which shows a modulus difference before and after magnetic field application. It is also an object of the present invention to improve the mechanical properties of an anisotropic MRE, in which the strength of a magnetic field can be adjusted. It is a further object of the present invention to improve the CIP orientation in the resulting MRE.

In one aspect, the present invention provides an electromagnetic device for manufacturing an anisotropic MRE, having two upper and lower electromagnet coils, and a test piece mold positioning part disposed between the electromagnet coils, wherein the electromagnet coils are configured in such a manner that the strength of a magnetic field to a test piece mold can be controlled by a current applied from a power controller.

When the electromagnetic device of the invention is used to manufacture an anisotropic MRE, it is possible to control the strength of a magnetic field, which reduces or eliminates the generation of bubbles within an MRE test piece, thereby greatly improving the orientation property of the CIP. This increases the MR effect showing a modulus difference before and after magnetic field application.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows a photograph of a neodymium magnet used in conventional art manufacturing of an anisotropic MRE;

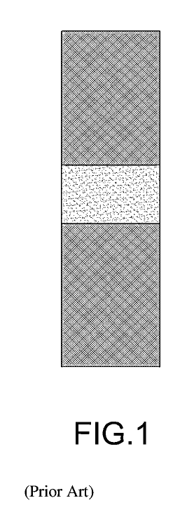

FIG. 2 shows a photograph of a conventional art MRE mold used in manufacturing an anisotropic MRE;

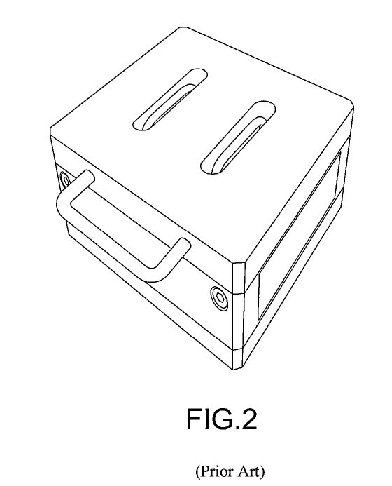

FIG. 3 is a conceptual view showing the state where CIP orientation is re-arranged by pressure when induced CIP arrangement in an anisotropic MRE manufactured by a conventional art device is subjected to pressure;

FIG. 4 shows an optical microscopic photograph (×50) of bubbles generated within a matrix in an anisotropic MRE manufactured by a conventional art device;

FIG. 5A is a view schematically showing an electromagnetic device for manufacturing an anisotropic magneto-rheological elastomer (MRE), according to an exemplary embodiment of the present invention;

FIG. 5B shows a photograph of an actual product of an electromagnetic device for manufacturing an anisotropic magneto-rheological elastomer (MRE), according to an exemplary embodiment of the present invention;

FIG. 6 is a conceptual view showing a state where CIP is interfacial-bonded to a natural rubber matrix by a silane coupling agent layer when an anisotropic MRE containing a

silane coupling agent-coated CIP is manufactured by the inventive device and the inventive manufacturing method;

FIG. 7 is a view showing a manufacturing process of an anisotropic MRE by using a device according to the present invention;

FIG. 8 shows an SEM photograph (×400) of a morphology of an isotropic MRE, as the result of Test Example 1 according to the present invention;

FIG. 9 shows an SEM photograph (×400) of a morphology of an anisotropic MRE, as the result of Test Example 1 according to the present invention;

FIG. 10 shows an SEM photograph (×400) of a morphology of an anisotropic MRE manufactured by using a neodymium magnet, as the result of Test Example 2 according to the present invention;

FIG. 11 shows an SEM photograph (×400) of a morphology of an anisotropic MRE manufactured by using an MRE mold, as the result of Test Example 2 according to the present invention;

FIG. 12 shows an SEM photograph (×400) of a morphology of an anisotropic MRE manufactured by using an electromagnetic device, as the result of Test Example 2 according to the present invention;

FIG. 13 shows an SEM photograph (×400) of a morphology of an MRE manufactured by the addition of non-coated CIP, as the result of Test Example 4 according to the present invention;

FIG. 14 shows an SEM photograph (×400) of a morphology of an MRE manufactured by the addition of coated CIP, as the result of Test Example 4 according to the present invention;

FIG. 15 is a conceptual view showing an FFT Analyzer for measuring a magnetorheological effect, used in Test Example 5 according to the present invention; and

FIG. 16 is a graph showing a magnetorheological effect according to the coating of a silane coupling agent on CIP, in Test Example 5 according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Hereinafter, an exemplary embodiment of the present invention will be described in more detail.

The inventive device has two upper and lower electromagnet coils, in which an anisotropic magnetorheological elastomer (MRE) is manufactured by orienting carbonyl iron powder (CIP) dispersed in natural rubber used as a matrix in the application direction of a magnetic field. This increases a magnetorheological effect showing a modulus difference before and after magnetic field application. In order to improve the magnetorheological effect, an exemplary embodiment of the invention uses as a raw material for manufacturing an anisotropic MRE, a compound obtained by mixing natural rubber (as matrix) with conventional additives and CIP.

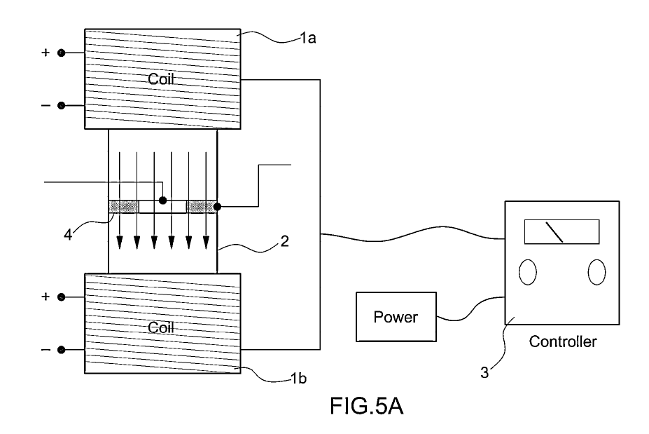

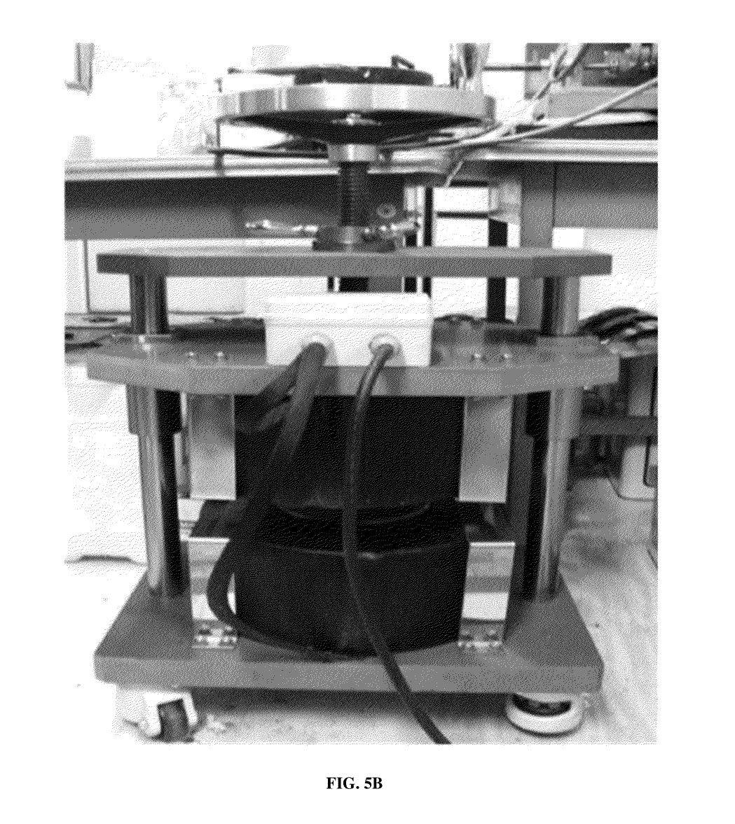

In the electromagnetic device according to an exemplary embodiment of the present invention, as shown in FIG. 5A (the conceptual view of the electromagnetic device), two upper 1A and lower 1B electromagnet coils are disposed, and a test piece mold 2 positioning part of a MRE is disposed between the coils, wherein the electromagnet coils are configured in such a manner that the strength of a magnetic field applied to a test piece mold can be controlled by a current applied from a power controller. Herein, the magnetic field is applied in the thickness direction of the test piece disposed on the test piece mold positioning part.

With respect to the orientation of CIP by the inventive electromagnetic device, it is preferable that an anisotropic MRE is manufactured by applying a magnetic field to an MRE test piece through a test piece mold (having a thickness ranging from about 25 to about 40 mm, and more preferably from about 30 to about 35 mm) of the electromagnetic device. Herein, the CIP is oriented in the thickness direction of the test piece. Thus, when the thickness is too thin, it may be difficult to measure the orientation effect; conversely, when the thickness is too thick, the orientation may be insufficiently carried out due to low strength of the magnetic field.

According to an exemplary embodiment of the present invention, the electromagnetic device may be manufactured as shown in FIG. 5B.

In the inventive electromagnetic device, the MRE test piece mold is positioned in such a manner that the CIP dispersed in the natural rubber used as a matrix may be oriented in the direction in which magnetic field is applied. Accordingly, when the magnetic field is applied, a CIP-oriented MRE is manufactured. When the anisotropic MRE is manufactured in this manner, it is possible to achieve a very high magnetorheological effect showing a modulus difference before and after magnetic field application.

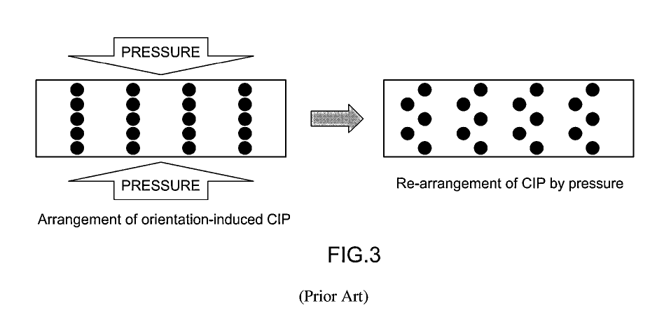

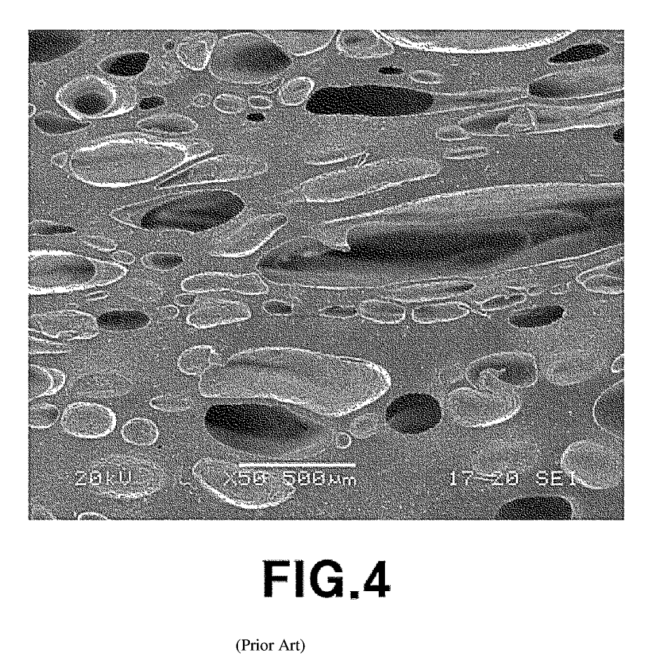

The present invention makes it possible to control the strength of the magnetic field, which makes it possible, for example, to apply a higher strength magnetic field. Additionally, the present invention makes it possible to reduce or eliminate the formation of bubbles within the test piece, and to produce a highly oriented/aligned CIP structure, because the MRE test piece mold is disposed between the electromagnets, subjected to induction of CIP orientation, and then transferred to a hydraulic press so that a test piece can be molded. Thus, it is possible to solve the problems of conventional anisotropic MRE manufacturing devices, such as re-arrangement of oriented CIP as shown in FIG. 3, and generation of bubbles within the test piece as shown in FIG. 4.

According an exemplary embodiment of the present invention, in order to effectively manufacture an anisotropic MRE, while the above described electromagnetic device is used, a CIP-containing matrix made of natural rubber is surface-coated with a silane coupling agent.

According to an exemplary embodiment of the present invention, in the matrix for manufacturing an anisotropic MRE,

(a) as a matrix substrate, natural rubber is used;

(b) CIP coated with a silane coupling agent is used, wherein the silane coupling agent is added in an amount of about 5.0 to about 50 Vol % with respect to the total coating solution; and

(c) as other additives, sulfur as a curing agent in an amount of about 1 to about 5 Phr, ZnO and stearic acid each as an activator in an amount of about 2 to about 6 Phr, and sulfenamide as an accelerator in an amount of about 0.5 to about 3 Phr may be used in combination.

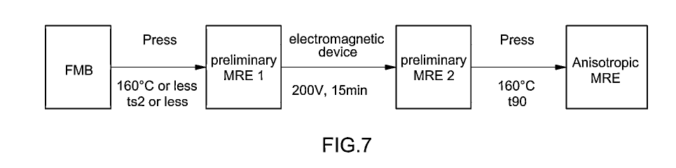

Hereinafter, the process for manufacturing an anisotropic MRE by using the inventive electromagnetic device will be described according to an exemplary embodiment of the present invention, as shown in FIG. 7.

First, natural rubber, various kinds of additives, and CIP are blended through roll-milling, and the rubber blend is introduced to an electromagnetic device mold, and firstly molded in a hydraulic press (at about 100° C.) for a scorch time or less so as to provide a sheet with a thickness of about 2 to about 4 mm. Herein, it is important to control the processing conditions in such a manner that scorching (that is, curing) of the matrix cannot be proceeded.

The first molded product, remaining in the mold, is positioned in an electromagnetic device. Then, under an optimum process condition according to the present invention, that is, at about 170 to about 230 V for 5-30 min, a secondly molded product is manufactured by inducing the orientation of the CIP. Finally, the secondly molded product is cured in a hydraulic press (set temperature: about 150° C. to about 180° C.) for an optimum curing time measured by a rubber rheometer so as to manufacture a final anisotropic MRE.

As shown in FIG. 5A, in the inventive electromagnetic device, a test piece mold is positioned between two upper and lower electromagnet coils, and it is possible to vary the current applied from a power controller, wherein the electromagnet coils are configured in such a manner that the strength of a magnetic field can be controlled according to the current. When the current is applied to the test piece, the CIP particles dispersed within the test piece are oriented in the thickness direction of the test piece.

Also, according to the present invention, as the distance between the two upper and lower coils increases, the strength of the applied magnetic field is reduced. The distance between the two coils preferably ranges from about 10 to about 50 mm, and more preferably ranges from about 25 to about 35 mm. For example, in the inventive device, even with a distance of 34 mm, it is possible to achieve a magnetic field strength of 0.85 Tesla. Such a value is 1.6 times higher than that of a conventional neodymium magnet. Thus, it can be determined that the electromagnetic device is more efficient than the conventional art.

Accordingly, through the inventive electromagnetic device, it is possible to more efficiently induce CIP orientation. Also, when the anisotropic MRE is manufactured with the CIP oriented according to the invention, a magnetorheological effect showing a modulus difference before and after magnetic field application is improved.

According to the present invention, when the anisotropic MRE is manufactured, the optimum process conditions of the electromagnetic device include a voltage ranging from about 190 to about 210V, and a treatment time of about 10-20 minutes.

Also, according to the present invention, based on the finding that the improvement of an interfacial adhesive strength between a natural rubber matrix and CIP can increase the magnetorheological effect and the mechanical property of an MRE, a silane coupling agent is used to coat the CIP so as to manufacture an anisotropic MRE with better physical properties.

As the silane coupling agent in the present invention, for example, an amino silane coupling agent (A1130) may be used, which is represented by Formula 1 below.

H₂NCH₂CH₂NHCH₂CH₂NHCH₂CH₂CH₂Si(OCH₃)₃ [Formula 1]

In the present invention, in the coating of the CIP with the silane coupling agent, first, an aqueous solution having a volumetric ratio of ethanol/water of 80-98/20-2 is combined with acetic acid so as to provide a solution of about pH 4-6, and then a silane coupling agent (A1130) is added in an amount of about 0.1-50 vol %, and more preferably of about 1-5 vol %, thereto, followed by stirring so as to induce sufficient hydrolysis of the silane coupling agent.

Then, CIP is added thereto, followed by stifling. The resulting mixture is then dried at room temperature so that a silane coupling agent-coated CIP can be produced. In the silane coupling agent-coated CIP, the condensation between a silanol group and CIP is achieved, and there remains a site reactable with a natural rubber matrix.

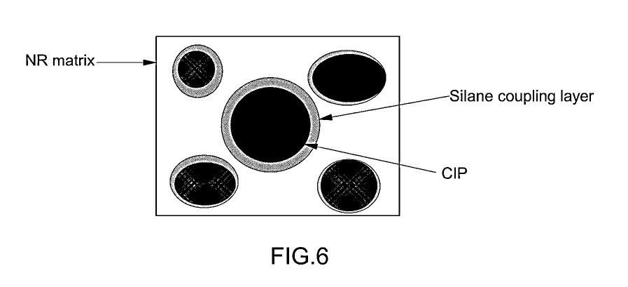

When an anisotropic MRE added with a silane coupling agent-coated CIP is manufactured with the inventive device and the inventive manufacturing method, the interfacial bonding between the CIP and the natural rubber matrix is achieved by the silane coupling agent layer as shown in FIG. 6. When the interfacial bonding is achieved, it is possible to improve the physical properties of the MRE and to further facilitate the CIP orientation. Accordingly, a magnetorheological effect showing a modulus difference before and after magnetic field application is also improved.

### EXAMPLES

The following examples illustrate the invention and are not intended to limit the same. Hereinafter, the present invention will be described in detail with reference to Examples, but the Examples do not limit the scope of the present invention.

### Example 1

Natural rubber used as a matrix, various kinds of additives, and CIP were roll-milled to provide a rubber compound. The rubber compound was firstly molded in a hydraulic press (100° C.) for a scorch time or less so as to provide a sheet with a thickness of 2 to 4 mm. Herein, it is important to control the processing condition in such a manner that scorching (that is, curing) of the matrix cannot be proceeded. The first molded product, remaining in the mold, was positioned in an electromagnetic device. Then, under an optimum process condition set in the present invention, that is, at 200 V for 15 min, a second molded product was manufactured by inducing the orientation of CIP. Finally, the second molded product was cured in a hydraulic press (set temperature: 160° C.) for an optimum curing time measured by a rubber rheometer so as to manufacture a final anisotropic MRE.

### Example 2

Natural rubber, additives, and CIP were blended through roll-milling in the same manner as described in Example 1. Then, the rubber blend was introduced into a hydraulic press without being applied with a magnetic field through an electromagnetic device, and cured for a final curing time measured by a rubber rheometer so as to manufacture an isotropic MRE having CIP particles randomly dispersed therein.

### Example 3

Magnetic responsive particles (CIP) were coated with a silane coupling agent by the following steps. First, an aqueous solution (Ethanol/Water=95/5) was added with acetic acid so as to provide a solution of pH 5, and then a silane coupling agent (A1130) was added in an amount of 2 vol % thereto, followed by stifling for 5 minutes so as to induce sufficient hydrolysis of the silane coupling agent.

Then, CIP was added thereto, followed by stirring for 3 minutes. The resulting mixture was dried at room temperature so that a silane-coated CIP was produced. In the silane-coated CIP, the condensation between a silanol group and CIP was achieved, and there remains a site reactable with natural rubber.

### Example 4

An anisotropic MRE was manufactured by orienting CIP through an electromagnetic device in the same manner as described in Example 1 except that CIP surface-coated with a silane coupling agent was used.

### Comparative Example 1

An anisotropic MRE was manufactured by induction of CIP orientation through the inventive electromagnetic device, and an isotropic MRE was manufactured by being cured without induction of CIP orientation.

### Comparative Example 2

Anisotropic MREs were manufactured by the inventive electromagnetic device and conventional devices (a neodymium magnet, and an MRE manufacturing mold).

### Comparative Example 3

Anisotropic MREs were manufactured by addition of silane coupling agent-coated CIP, and by addition of non-coated CIP, respectively.

### TEST EXAMPLES

### Test Example 1

### Analysis of Morphologies of an Isotropic MRE and an Anisotropic MRE

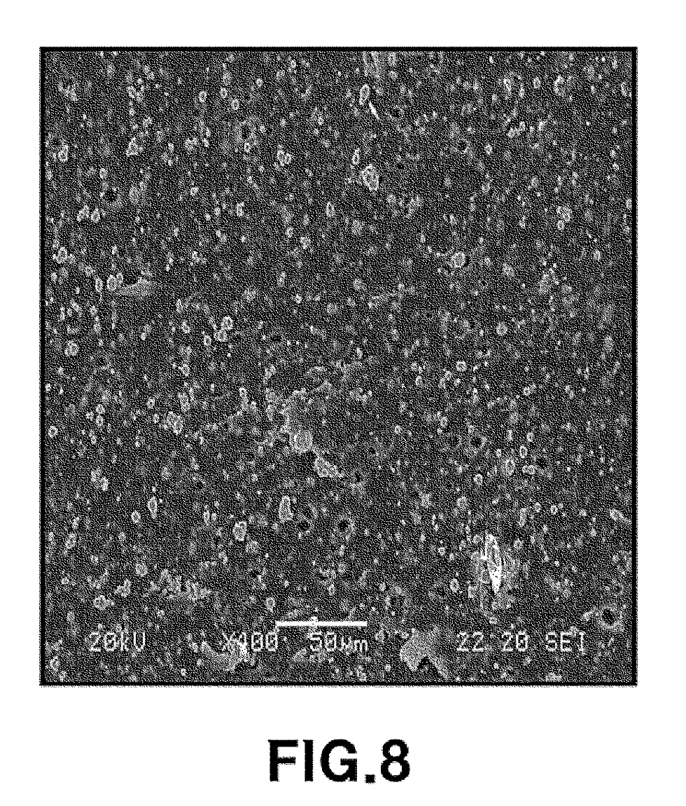

An anisotropic MRE was manufactured by induction of CIP orientation through the inventive electromagnetic device, and an isotropic MRE was manufactured by being cured without induction of CIP orientation. Then, their morphologies were analyzed by SEM. The results are shown in photographs of FIGS. 8 (isotropic) and 9 (anisotropic).

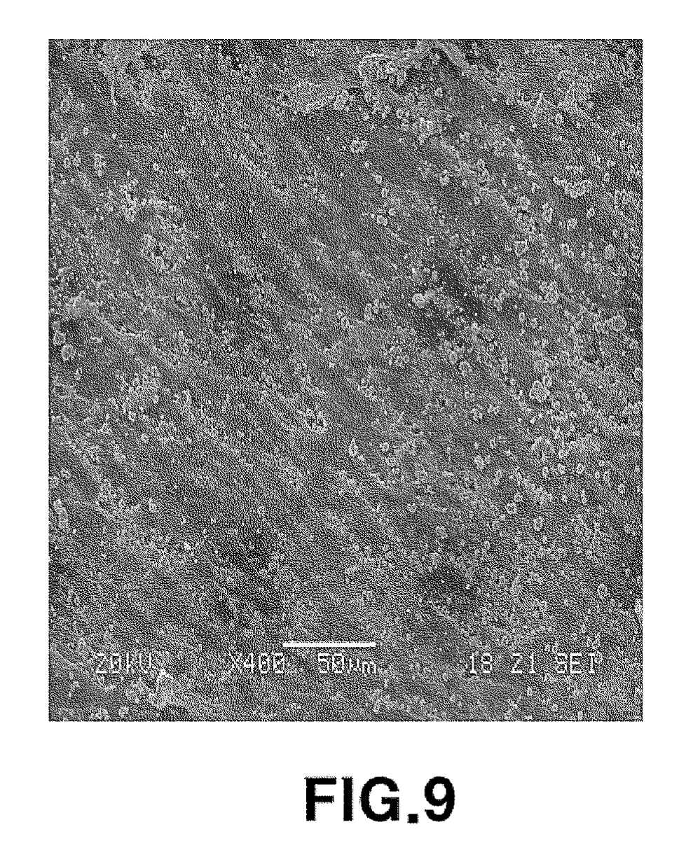

As shown in FIGS. 8 and 9, in the isotropic MRE, CIP particles are uniformly dispersed within the natural rubber, while in the anisotropic MRE (FIG. 9) manufactured by CIP orientation through the electromagnetic device, CIP particles are oriented in the application direction of a magnetic field within the natural rubber.

### Test Example 2

### Analysis of Morphologies of Anisotropic MREs Manufactured by a Conventional Art CIP Orientation Device, and the Inventive Electromagnetic Device

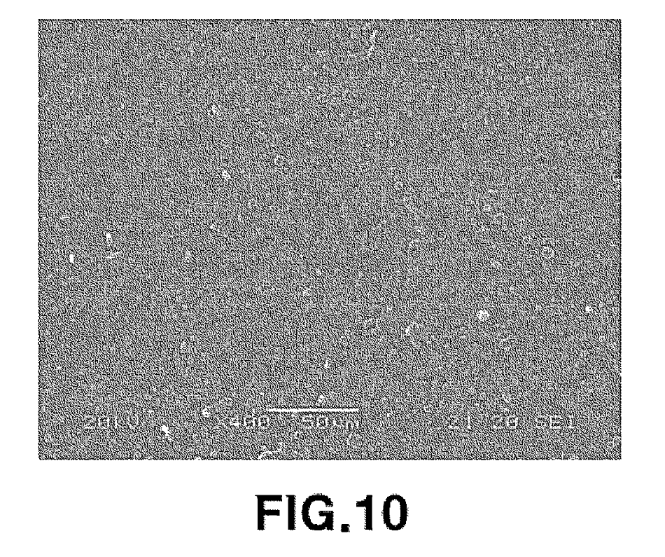

The morphologies of an anisotropic MRE manufactured by the inventive electromagnetic device, and anisotropic MREs manufactured by conventional devices (such as a neodymium magnet and an MRE manufacturing mold), were compared. The results are shown in FIGS. 10 (neodymium magnet), 11 (mold), and 12 (electromagnetic device).

First, FIG. 10 shows the morphology of an anisotropic MRE manufactured by a neodymium magnet. Herein, although a magnetic field was applied, the morphology was almost similar to that of an isotropic MRE. When a compression molding step for curing was carried out after application of a magnetic field through a neodymium magnet, oriented CIP particles were re-arranged by the pressure. Thus, it was impossible to achieve the orientation property of CIP, and the morphology was similar to that of an isotropic MRE.

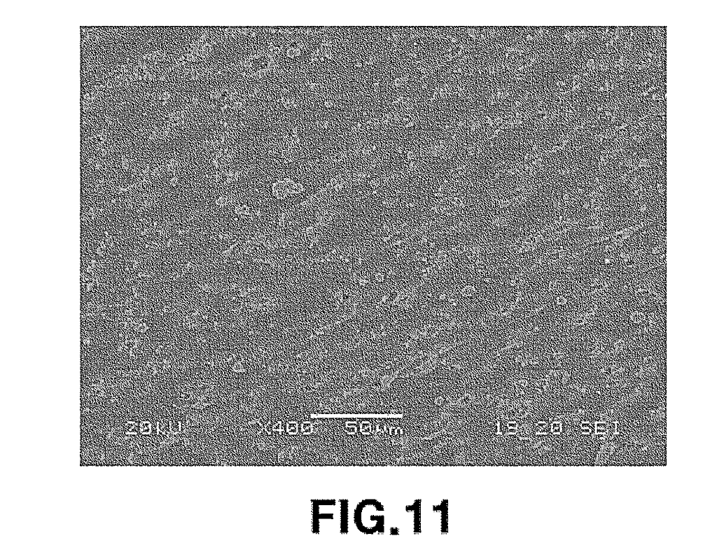

FIG. 11 shows the morphology of an anisotropic MRE manufactured by an MRE manufacturing mold. Since the strength of a magnetic field applied for the orientation property of CIP was weak, it was impossible to achieve CIP orientation to any significant extent despite the application of the magnetic field.

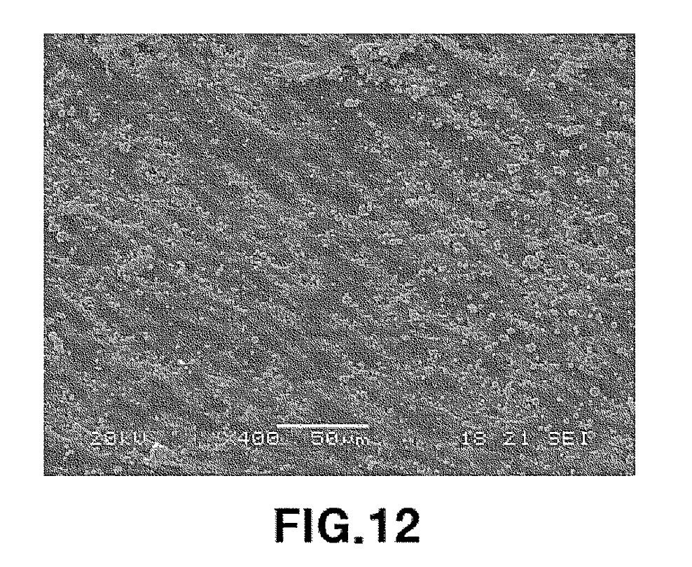

Meanwhile, as shown in FIG. 12, in the anisotropic MRE manufactured by the inventive electromagnetic device, unlike in the MREs manufactured by conventional devices such as a neodymium magnet and an MRE manufacturing mold, it was found that the strength of a magnetic field can be controlled, and some problems such as the generation of bubbles within a test piece, and the re-arrangement of CIP orientation can be solved. In other words, it was possible to achieve a much more significant orientation of CIP.

### Test Example 3

### Analysis on Physical Properties According to Silane Coating of CIP

Anisotropic MREs were manufactured by the addition of silane coupling agent-coated CIP and non-coated CIP, respectively, and by the application of a magnetic field through an electromagnetic device. Then, the mechanical properties were compared, and the results are noted in Table 1.

TABLE 1

| | Coated CIP | Non-coated CIP |
|---|---|---|
| Tensile strength (MPa) | 10.25 ± 0.66 | 13.51 ± 2.11 |
| Elongation (%) | 499 ± 19 | 586 ± 33 |

As noted in Table 1, it can be found that the MRE manufactured by using coated CIP has a lower tensile strength than the MRE manufactured by using non-coated CIP. This is because the use of coated CIP increased the interfacial bonding strength between natural rubber and CIP, thereby increasing the orientation of CIP.

### Test Example 4

### Analysis on Morphology According to Silane Coating of CIP

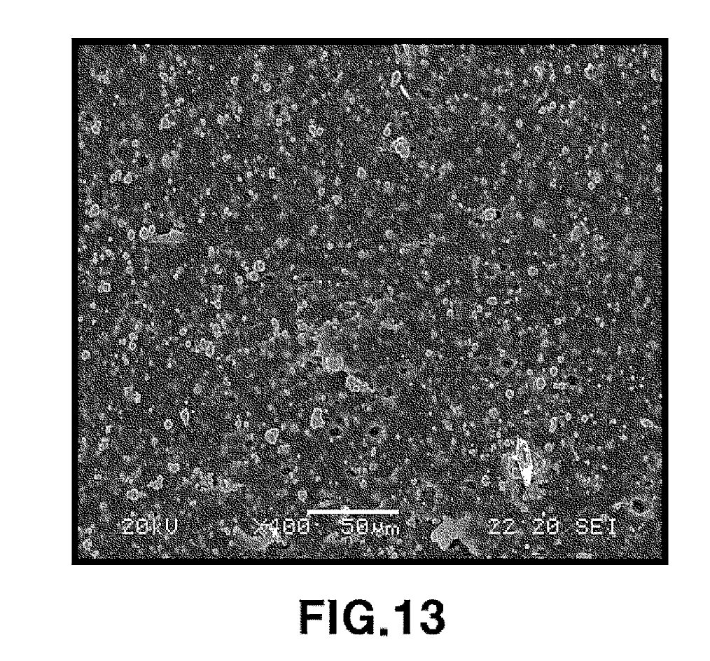

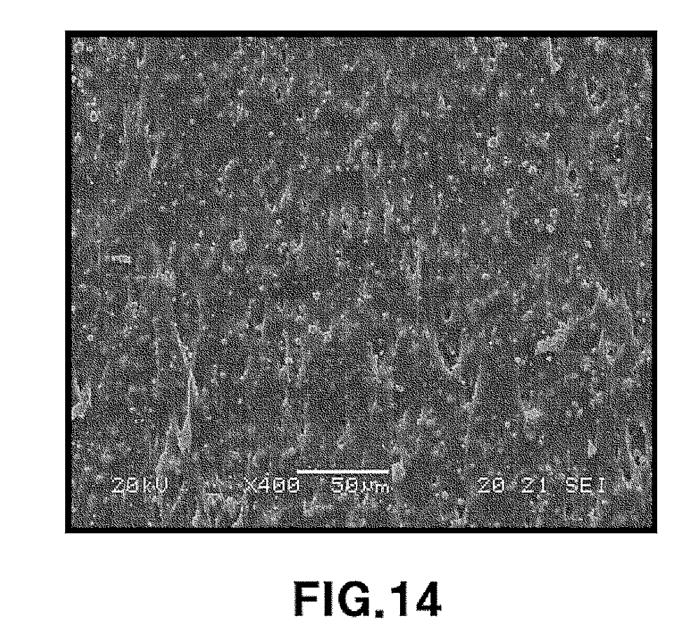

The morphologies according to silane coating of CIP are shown in FIGS. 13 and 14.

FIG. 13 is a photograph of the morphology of an MRE manufactured by the addition of non-coated CIP, and FIG. 14 is an SEM photograph of the morphology of an MRE manufactured by the addition of coated CIP.

Unlike in the MRE shown in FIG. 13, in the MRE manufactured by the addition of coated CIP, shown in FIG. 14, CIP particles were more sufficiently bonded to natural rubber because the interfacial bonding strength between the natural rubber and the CIP was increased. Accordingly, the orientation property of CIP was increased, resulting in a higher magnetorheological effect.

### Test Example 5

### Analysis on a Magnetorheological Effect According to the Coating of a Silane Coupling Agent on CIP

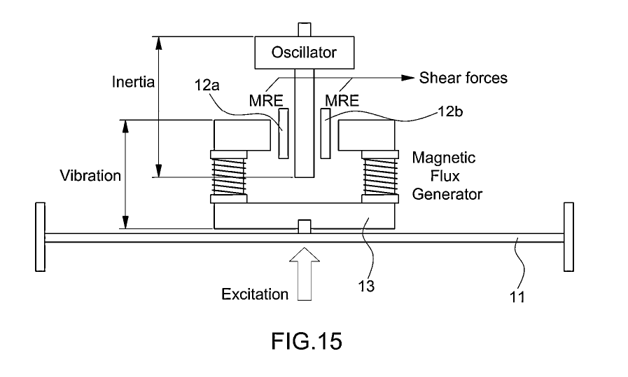

A magneto-rheological effect, as a variation ratio of modulus before and after magnetic field application, was measured by an FFT Analyzer as shown in FIG. 15. In the FFT Analyzer, the entire system was fixed on an iron beam 11 having both ends fixed so as to accurately operate the entire system and perform measurement, and a mass capable of providing a magnetic field was fixed by 2 MRE test pieces, 12A and 12B. In the configuration, the frequency of a vibration input from the lower end is measured by an accelerometer 13 at the lower end so that a change in shear modulus of an MRE according to magnetic flux density of an applied magnetic field could be measured.

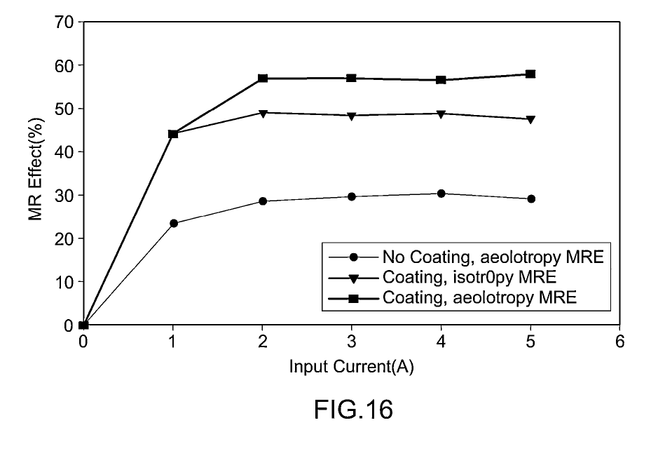

Through this device, the variation ratio of modulus was measured according to an applied current in MREs manufactured by the addition of silane-coated CIP or non-coated CIP. The magnetorheological effect according to the silane coating of CIP is shown in FIG. 16. In the graph of FIG. 16, the magnetorheological effect was generally increased according to the applied current. Also, the anisotropic MRE manufactured by the addition of coated CIP showed the highest magnetorheological effect. This is because the addition of coated CIP increased the interfacial adhesive strength between CIP and natural rubber, thereby improving the orientation of CIP.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An electromagnetic device for manufacturing an anisotropic magnetorheological elastomer (MRE), comprising:
at least two upper electromagnet coils,
at least two lower electromagnet coils, and
a test piece mold disposed between the at least two upper electromagnet coils and the at least two lower electromagnet coils, wherein the at least two upper and at least two lower electromagnet coils are configured to vary the strength of a magnetic field applied to the test piece mold.

2. The electromagnetic device of claim 1, wherein the strength of the magnetic field applied to the test piece mold is controlled by varying a current applied to the at least two upper and at least two lower electromagnet coils by a power controller.

3. The electromagnetic device of claim 1, wherein the test piece mold has a thickness ranging from 25 to 40 mm.

4. The electromagnetic device of claim 1, wherein the test piece mold has a thickness ranging from 30 to 35 mm.

5. The electromagnetic device of claim 1, wherein the test piece mold is oriented between the at least two upper and at least two lower electromagnet coils so that the magnetic field is applied in a direction corresponding to the thickness of the test piece mold.

6. A method for manufacturing an anisotropic magnetorheological elastomer, comprising:
synthesizing an MRE raw material;
placing the MRE raw material in the test piece mold of claim 1;
applying a magnetic field to the test piece mold; and
curing the MRE raw material subjected to the magnetic field, thereby producing an anisotropic MRE.

7. The method of claim 6, wherein the MRE raw material comprises a carbonyl iron powder (CIP) containing matrix.

8. The method of claim 7, wherein the matrix is natural rubber.

9. The method of claim 7, wherein the matrix is surface coated with a silane coupling agent

10. The method of claim 9, wherein the silane coupling agent is added in an amount of 5 to 50 Vol % with respect to a total coating solution.

11. The method of claim 7, wherein the MRE raw material further comprises a curing agent, an activator, and an accelerator.

12. The method of claim 11, wherein the curing agent is sulfur in an amount of 1 to 5 Phr.

13. The method of claim 11, wherein the activator is selected from the group consisting of ZnO, stearic acid, and any combination thereof.

14. The method of claim 13, where the activator is ZnO and stearic acid in an amount of 2 to 6 Phr.

15. The method of claim 11, wherein the accelerator is sulfenamide in an amount of 0.5 to 3 Phr,

16. The method of claim 7, wherein application of the magnetic field at 170 to 230 V for 5 to 30 minutes to the test piece molding containing the CIP containing matrix induces orientation of the CIP.

17. A MRE raw material for manufacturing an anisotropic magnetorheological elastomer, comprising:
natural rubber;
a silane coupling agent, wherein the silane coupling agent is added in an amount of 5 to 50 Vol % with respect to a total coating solution;
a curing agent, wherein the curing agent is present in an amount of 1 to 5 Phr;
an activator, wherein the activator is ZnO and stearic acid each in an amount of 2 to 6 Phr, and
an accelerator, wherein the accelerator is sulfenamide in an amount of 0.5 to 3 Phr.
